(19) United States
(12) Patent Application Publication
(10) Pub. No.: US 2024/0040269 A1
(43) Pub. Date: Feb. 1, 2024

(54) SENSOR CONFIGURATION FOR AUTONOMOUS VEHICLES

(71) Applicant: TUSIMPLE, INC., San Diego, CA (US)

(72) Inventors: Jianqiu CAO, Tucson, AZ (US); Tristan NGUYEN, San Diego, CA (US); Xiaoling HAN, San Diego, CA (US); Xiaodi HOU, San Diego, CA (US)

(21) Appl. No.: 18/356,905

(22) Filed: Jul. 21, 2023

Related U.S. Application Data
(60) Provisional application No. 63/369,497, filed on Jul. 26, 2022.

(51) Int. Cl. H04N 23/90; B60W 60/00; H04N 13/239; G06T 7/593; G06T 7/292

(52) U.S. Cl. CPC H04N 23/90; B60W 60/001; H04N 13/239; G06T 7/593; G06T 7/292; B60W 2420/42; B60W 2420/40; B60W 2420/52; B60W 2554/4042; G06T 2207/30252

(57) ABSTRACT

Embodiments are disclosed for providing full and redundant sensor coverage for an environment surrounding a vehicle. An example vehicle includes a plurality of first cameras and a plurality of second cameras. The first cameras are associated with a first field-of-view (FOV) having a first horizontal aspect, and the second cameras are associated with a second FOV having a second horizontal aspect. The first cameras and the second cameras are located at different angular locations on the vehicle along a horizontal plane. Horizontal aspects of two FOVs of any two consecutive cameras located along the horizontal plane overlap in the horizontal plane by at least a predetermined degree. Another example vehicle includes a controller for controlling autonomous driving operation of the vehicle and a sensor network that includes at least six sensors. Directional beams corresponding to the sensors cover a surrounding region of the vehicle relevant to the autonomous driving operation.

### CROSS-REFERENCE TO RELATED APPLICATIONS

This document claims priority to and the benefit of U.S. Provisional Application No. 63/369,497, filed on Jul. 26, 2022. The aforementioned application of which is incorporated herein by reference in its entirety.

### TECHNICAL FIELD

This document relates to sensors for an autonomous vehicle, and specifically, the configuration, placement, and orientation of autonomous vehicle sensors.

### BACKGROUND

Autonomous vehicle navigation is a technology that can control the autonomous vehicle to safely navigate towards a destination. A prerequisite for safe navigation and control of the autonomous vehicle includes an ability to sense the position and movement of vehicles and other objects around an autonomous vehicle, such that the autonomous vehicle can be operated to avoid collisions with the vehicles or other objects. Thus, multiple sensors located on a vehicle that can be used for detecting objects external to the vehicle are needed for autonomous operation of a vehicle.

### SUMMARY

This patent document discloses example embodiments for providing full and redundant sensor coverage for an environment surrounding a vehicle. Example embodiments provide configurations of multiple sensors, including cameras, located on a vehicle for capturing a 360 degree environment of the vehicle, with certain sensors being redundant to others at least for improved object detection and tracking at high speeds. In some embodiments, sensor configurations capture the 360 degree environment surrounding the vehicle for up to 500 meters, 800 meters, 1000 meters, 1200 meters, or 1500 meters away from the vehicle. For example, various embodiments described herein may be used with an autonomous vehicle (e.g., for autonomous operation of a vehicle) to detect objects located outside of the autonomous vehicle, to track objects as the objects and/or the autonomous vehicle move relative to each other, to estimate distances between the autonomous vehicle and objects, and/or to provide continued operation in events of failure of individual sensors. Embodiments disclosed herein enable lane marking detection and traffic sign/light detection for autonomous operation of a vehicle.

In one exemplary aspect of the present disclosure, an autonomous vehicle is provided. The autonomous vehicle includes a plurality of first cameras associated with a first field-of-view (FOV) having a first horizontal aspect. The autonomous vehicle further includes a plurality of second cameras associated with a second FOV having a second horizontal aspect. The first cameras and the second cameras are located at different angular locations on the autonomous vehicle along a horizontal plane. The horizontal aspects of two fields-of-view of any two consecutive cameras located along the horizontal plane overlap in the horizontal plane by at least a predetermined number of degrees.

In another exemplary aspect, a sensor network for an autonomous vehicle is provided. The sensor network includes a plurality of first cameras associated with a first field-of-view (FOV) having a first horizontal aspect. The sensor network further includes a plurality of second cameras associated with a second FOV having a second horizontal aspect. The first cameras and the second cameras are located at different angular locations on the autonomous vehicle along a horizontal plane. The horizontal aspects of two fields-of-view of any two consecutive cameras located along the horizontal plane overlap in the horizontal plane by at least a predetermined number of degrees.

In yet another exemplary embodiment, a system for operating an autonomous vehicle is provided. The system includes a processor communicatively coupled with and configured to receive image data from a plurality of first cameras and a plurality of second cameras. The first cameras are associated with a first FOV having a first horizontal aspect, and the second cameras are associated with a second FOV having a second horizontal aspect. The first cameras and the second cameras are located at different angular locations on the autonomous vehicle along a horizontal plane. The horizontal aspects of two fields-of-view of any two consecutive cameras located along the horizontal plane overlap in the horizontal plane by at least a predetermined number of degrees.

In yet another exemplary aspect, a method for operating an autonomous vehicle is provided. The method includes receiving image data from a sensor network. The sensor network includes a plurality of first cameras associated with a first field-of-view (FOV) having a first horizontal aspect and a plurality of second cameras associated with a second FOV having a second horizontal aspect. The first cameras and the second cameras are located at different angular locations on the autonomous vehicle along a horizontal plane. Horizontal aspects of two fields-of-view of any two consecutive cameras located along the horizontal plane overlap in the horizontal plane by at least a predetermined number of degrees. The method further includes detecting one or more objects located outside of the autonomous vehicle based on the image data. The method further includes determining a trajectory for the autonomous vehicle based on the detection of the one or more objects. The method further includes causing the autonomous vehicle to travel in accordance with the trajectory.

In yet another exemplary aspect, an autonomous truck is disclosed. The autonomous truck includes a controller configured to control autonomous driving operation of the truck. The autonomous truck includes a sensor network including at least six sensors disposed on an exterior of the truck. Each sensor is oriented to capture sensor data from a corresponding directional beam having a corresponding beam width and a corresponding beam depth such that beam widths of the at least six sensors cover a surrounding region of the truck that is relevant to safe autonomous driving of the truck.

The above and other aspects and their implementations are described in greater detail in the drawings, the descriptions, and the claims.

### BRIEF DESCRIPTION OF THE DRAWING

FIG. 1 shows a block diagram of an example vehicle ecosystem in which an exemplary sensor system for an autonomous vehicle can be implemented.

FIG. 2 shows a diagram of a plurality of sensors located on a vehicle and having overlapping fields-of-view.

FIG. 3 shows a diagram of sensors having overlapping fields-of-view.

FIG. 4 shows a diagram of sensors of different types located on a vehicle and having overlapping fields-of-view.

FIG. 5 shows another diagram of sensors of different types located on a vehicle and having overlapping fields-of-view.

FIG. 6 shows yet another diagram of sensors of different types located on a vehicle and having overlapping fields-of-view.

FIG. 7 shows a diagram of sensors being located on a vehicle and oriented to cover a range of orientations.

FIG. 8 shows a diagram of sensors being located on a vehicle and oriented to cover a range of orientations.

FIG. 9 shows a diagram of sensors being located on a vehicle and oriented to cover a range of orientations.

FIG. 10 shows a diagram of sensors being located on a vehicle and oriented to cover a range of orientations.

FIG. 11 shows a diagram of sensors including infrared cameras that are located on a vehicle and oriented to cover a range of orientations.

### DETAILED DESCRIPTION

Development of autonomous driving technology hinges on the ability to detect and be aware of the surrounding environment of a vehicle. In a conventional vehicle without autonomous driving capabilities, a human operator or driver visually collects information of the surrounding environment surrounding environment intuitively interprets the visually-collected information to operate the vehicle. In conventional vehicles relying upon human operation, human operators are limited to a field-of-view and need physical mobility to allow visual observation of wider orientations.

To observe and collect data on the surrounding environment, an autonomous vehicle may include multiple sensors, including cameras and light detection and ranging (LiDAR) sensors, located on the autonomous vehicle. Various technical challenges have stood in the way of autonomous systems reaching full environmental awareness or human-level awareness of the environment surrounding the autonomous vehicle. For example, blind spots or gaps in sensor coverage may exist in some existing approaches, and further, resource costs such as communication bandwidth and data storage may limit an exceedingly large number of sensors from being implemented. Further, autonomous vehicles may operate in high-speed environments in which objects are in motion relative to an autonomous vehicle at a high speed, and such objects moving at high speeds may go undetected by inadequate existing approaches. Even further, some existing approaches are vulnerable to localized physical damage that can cause failure in a significant number of sensors located on a vehicle, and individual failures of sensors may result in significant portions of the environment going undetected.

Thus, to address at least the above-identified technical issues, this patent document describes sensor configurations and layouts that are optimized and configured to provide enhanced environmental awareness for an autonomous vehicle. In example embodiments, sensor configurations and layouts refers to configurations of position and orientation of cameras located along an exterior of the vehicle. The cameras include long range cameras, medium range cameras, short range cameras, wide-angle/fisheye cameras, and infrared cameras. As such, example configurations and layouts include a heterogenous set of camera types.

In particular, various embodiments described herein are configured to provide vision in 360 degrees surrounding the autonomous vehicle. According to various embodiments described herein, sensors are configured (e.g., located and oriented) such that the fields-of-view (FOVs) of the sensors overlap with each other by at least a predetermined amount. In some embodiments, the FOVs of the sensors overlap with each other by at least 15 degrees in a horizontal aspect, for example. In some embodiments, FOVs of the sensors overlap horizontally by at least 10 degrees, at least 12 degrees, at least 15 degrees, at least 17 degrees, or at least 20 degrees. In some embodiments, the FOVs of the sensors may overlap based on a predetermined amount based on a percent of area covered.

Example embodiments include sensors with different sensor ranges, such that environmental awareness at different distances from the autonomous vehicle is provided in addition to the enhanced environmental awareness at 360 degrees of orientations about the autonomous vehicle. With overlapped FOVs, the sensors can provide improved object tracking and improved redundancy in case of individual sensor failure. For example, the amount by which the sensor FOVs overlap may be configured such that high-speed objects can be reliably captured by at least two sensors.

In some embodiments, redundant sensors (e.g., sensors with overlapped FOVs) are configured to support each other in the event of failure or deficiency of an individual sensor. For example, embodiments disclosed address sensor failure conditions that include components failures, loss of connection (e.g., wired connections or wireless connections), local impacts and physical damage (e.g., an individual sensor being damaged due to a debris colliding with the sensor), global environmental impacts (e.g., rain or dense fog affecting vision capabilities of an individual sensor or a homogenous sensor configuration), and/or the like. In some embodiments, the sensors may be located along the autonomous vehicle to enable stereovision or binocular-based distance estimations of detected objects.

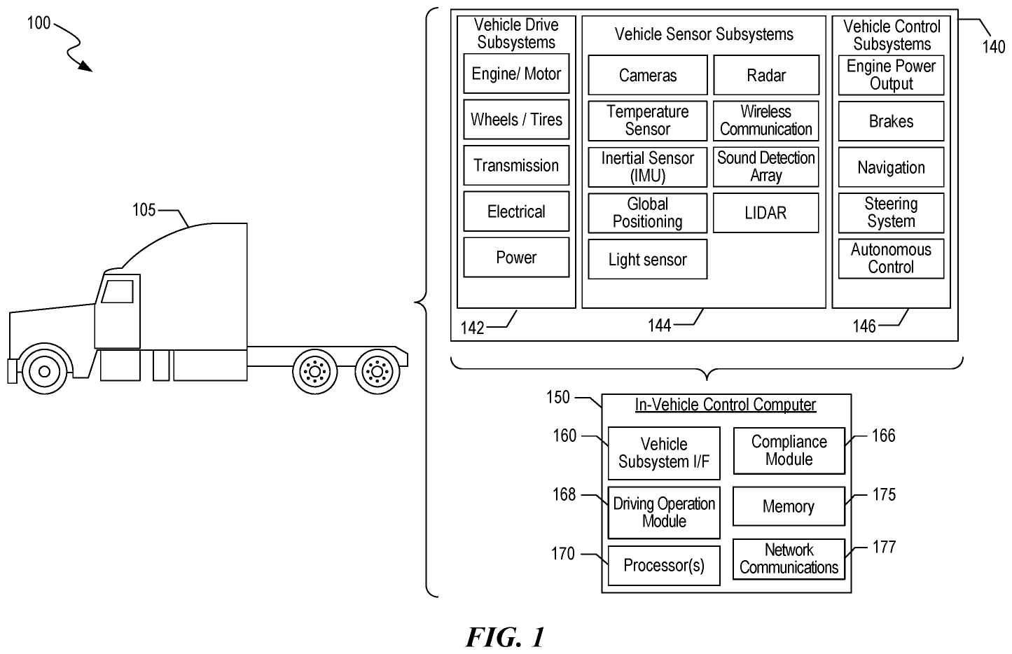

FIG. 1 shows a block diagram of an example vehicle ecosystem 100 in which an exemplary power management system for an autonomous vehicle 105 can be implemented. The vehicle ecosystem 100 includes several systems and electrical devices that can generate and/or deliver one or more sources of information/data and related services to the in-vehicle control computer 150 that may be located in an autonomous vehicle 105. Examples of autonomous vehicle 105 include a car, a truck, or a semi-trailer truck. The in-vehicle control computer 150 can be in data communication with a plurality of vehicle subsystems 140, all of which can be resident in an autonomous vehicle 105. A vehicle subsystem interface 160 is provided to facilitate data communication between the in-vehicle control computer 150 and the plurality of vehicle subsystems 140. The vehicle subsystem interface can include a wireless transceiver, a Controller Area Network (CAN) transceiver, an Ethernet transceiver, serial ports, gigabit multimedia serial link 2 (GMSL2) ports, local interconnect network (LIN) ports, or any combination thereof.

The autonomous vehicle 105 may include various vehicle subsystems that support of the operation of autonomous vehicle 105. The vehicle subsystems may include a vehicle drive subsystem 142, a vehicle sensor subsystem 144, a vehicle control subsystem 146 and/or a vehicle power subsystem 148. The vehicle drive subsystem 142 may include components operable to provide powered motion for the autonomous vehicle 105. In an example embodiment, the vehicle drive subsystem 142 may include an engine or motor, wheels/tires, a transmission, an electrical subsystem, and a power source (e.g., battery and/or alternator).

The vehicle sensor subsystem 144 may include a number of sensors configured to sense information about an environment or condition of the autonomous vehicle 105. For example, the vehicle sensor subsystem 144 may include an inertial measurement unit (IMU), a Global Positioning System (GPS) transceiver, a RADAR unit, a laser range finder or a light detection and ranging (LiDAR) unit, and/or one or more cameras or image capture devices. The vehicle sensor subsystem 144 may also include sensors configured to monitor internal systems of the autonomous vehicle 105 (e.g., an O₂ monitor, a fuel gauge, an engine oil temperature).

The IMU may include any combination of sensors (e.g., accelerometers and gyroscopes) configured to sense position and orientation changes of the autonomous vehicle 105 based on inertial acceleration. The GPS transceiver may be any sensor configured to estimate a geographic location of the autonomous vehicle 105. For this purpose, the GPS transceiver may include a receiver/transmitter operable to provide information regarding the position of the autonomous vehicle 105 with respect to the Earth. The RADAR unit may represent a system that utilizes radio signals to sense objects within the local environment of the autonomous vehicle 105. In some embodiments, in addition to sensing the objects, the RADAR unit may additionally be configured to sense the speed and the heading of the objects proximate to the autonomous vehicle 105. The laser range finder or LIDAR unit may be any sensor configured to sense objects in the environment in which the autonomous vehicle 105 is located using lasers. The cameras may include one or more devices configured to capture a plurality of images of the environment of the autonomous vehicle 105. The cameras may be still image cameras or motion video cameras.

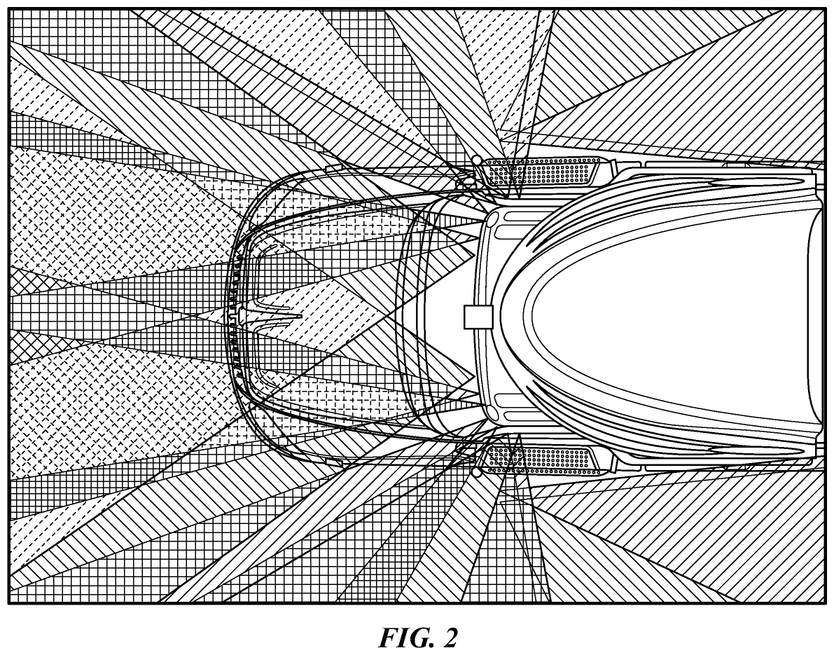

The cameras, the LiDAR units, or other external-facing visual-based sensors (e.g., sensors configured to image the external environment of the vehicle) of the vehicle sensor subsystem 144 may be located and oriented along the autonomous vehicle in accordance with various embodiments described herein, including those illustrated in FIGS. 2-10. In some embodiments, the external-facing visual-based sensors (e.g., cameras, LiDAR units) are located along the autonomous vehicle with respect to a horizontal plane of the autonomous vehicle and oriented such that the FOVs of two adjacent or consecutive sensors, or two sensors located nearest to each other, overlap by at least a predetermined amount. In some embodiments, FOVs of adjacent sensors may overlap by at least 10 degrees horizontally, at least 12 degrees horizontally, at least 15 degrees horizontally, at least 17 degrees horizontally, or at least 20 degrees horizontally. In some embodiments, FOVs of adjacent sensors may overlap horizontally by at least an amount based on a frame rate of the adjacent sensors and an expected speed of objects desired to be detected by the sensors. For example, for sensors being operated at a low rate, the sensor FOV overlap may be a larger amount to compensate for the low sensor frequency.

In some embodiments, the vehicle sensor subsystem 144 includes cameras that have different optical characteristics. For example, the vehicle sensor subsystem 144 includes one or more long-range cameras, one or more medium-range cameras, one or more short-range cameras, one or more wide-angle lens cameras, one or more infrared cameras, or the like. Different cameras having different ranges have different fields-of-view, and a range of a camera may be correlated with (e.g., and inversely proportional to) the field-of-view of the camera. For example, a long-range camera may have a field-of-view with a relatively narrow horizontal aspect, while a short-range camera may have a field-of-view with a relatively wider horizontal aspect. In some embodiments, the vehicle sensor subsystem 144 includes cameras of different ranges on a plurality of faces or orientations on the autonomous vehicle to reduce blind spots.

In some embodiments, the vehicle sensor subsystem 144 may be communicably coupled with the in-vehicle control computer 150 such that data collected by various sensors of the vehicle sensor subsystem 144 (e.g., cameras, LiDAR units) may be provided to the in-vehicle control computer 150. For example, the vehicle sensor subsystem 144 may include a central unit to which the sensors are coupled, and the central unit may be configured to communicate with the in-vehicle control computer 150 via wired or wireless communication. The central unit may include multiple ports and serializer/deserializer units to which multiple sensors may be connected. In some embodiments, for localize individual failure events, sensors configured to be redundant with each other (e.g., two cameras with overlapped FOVs) may be connected to the central unit and/or to the in-vehicle control computer via different ports or interfaces, for example.

The vehicle control system 146 may be configured to control operation of the autonomous vehicle 105 and its components. Accordingly, the vehicle control system 146 may include various elements such as a throttle, a brake unit, a navigation unit, and/or a steering system.

The throttle may be configured to control, for instance, the operating speed of the engine and, in turn, control the speed of the autonomous vehicle 105. The brake unit can include any combination of mechanisms configured to decelerate the autonomous vehicle 105. The brake unit can use friction to slow the wheels in a standard manner. The navigation unit may be any system configured to determine a driving path or route for the autonomous vehicle 105. The navigation unit may additionally be configured to update the driving path dynamically while the autonomous vehicle 105 is in operation. In some embodiments, the navigation unit may be configured to incorporate data from the GPS transceiver and one or more predetermined maps so as to determine the driving path for the autonomous vehicle 105.

The vehicle control system 146 may be configured to control operation of power distribution units located in the autonomous vehicle 105. The power distribution units have an input that is directly or indirectly electrically connected to the power source of the autonomous vehicle 105 (e.g., alternator). Each power distribution unit can have one or more electrical receptacles or one or more electrical connectors to provide power to one or more devices of the autonomous vehicle 105. For example, various sensors of the vehicle sensor subsystem 144 such as cameras and LiDAR units may receive power from one or more power distribution units. The vehicle control system 146 can also include power controller units, where each power controller unit can communicate with a power distribution unit and provide information about the power distribution unit to the in-vehicle control computer 150, for example.

Many or all of the functions of the autonomous vehicle 105 can be controlled by the in-vehicle control computer 150. The in-vehicle control computer 150 may include at least one data processor 170 (which can include at least one microprocessor) that executes processing instructions stored in a non-transitory computer readable medium, such as the data storage device 175 or memory. The in-vehicle control computer 150 may also represent a plurality of computing devices that may serve to control individual components or subsystems of the autonomous vehicle 105 in a distributed fashion. In some embodiments, the data storage device 175 may contain processing instructions (e.g., program logic) executable by the data processor 170 to perform various methods and/or functions of the autonomous vehicle 105, including those described in this patent document. For instance, the data processor 170 executes operations for processing image data collected by cameras (e.g., blur and/or distortion removal, image filtering, image correlation and alignment), detecting objects captured in image data collected by overlapped cameras (e.g., using computer vision and/or machine learning techniques), accessing camera metadata (e.g., optical characteristics of a camera), performing distance estimation for detected objects, or the like.

The data storage device 175 may contain additional instructions as well, including instructions to transmit data to, receive data from, interact with, or control one or more of the vehicle drive subsystem 142, the vehicle sensor subsystem 144, the vehicle control subsystem 146, and the vehicle power subsystem 148. In some embodiment, additional components or devices can be added to the various subsystems or one or more components or devices (e.g., temperature sensor shown in FIG. 1) can be removed without affecting various embodiments described in this patent document. The in-vehicle control computer 150 can be configured to include a data processor 170 and a data storage device 175.

The in-vehicle control computer 150 may control the function of the autonomous vehicle 105 based on inputs received from various vehicle subsystems (e.g., the vehicle drive subsystem 142, the vehicle sensor subsystem 144, the vehicle control subsystem 146, and the vehicle power subsystem 148). For example, the in-vehicle control computer 150 may use input from the vehicle control system 146 in order to control the steering system to avoid a high-speed vehicle detected in image data collected by overlapped cameras of the vehicle sensor subsystem 144, move in a controlled manner, or follow a path or trajectory. In an example embodiment, the in-vehicle control computer 150 can be operable to provide control over many aspects of the autonomous vehicle 105 and its subsystems. For example, the in-vehicle control computer 150 may transmit instructions or commands to cameras of the vehicle sensor subsystem 144 to collect image data at a specified time, to synchronize image collection rate or frame rate with other cameras or sensors, or the like. Thus, the in-vehicle control computer 150 and other devices, including cameras and sensors, may operate at a universal frequency, in some embodiments.

FIG. 2 shows a diagram of a plurality of sensors located on a vehicle that are configured to provide environmental awareness for autonomous systems of the vehicle (e.g., including the in-vehicle control computer 150) as well as their respective field-of-view. In particular, FIG. 2 illustrates cameras of the vehicle sensor subsystem 144 that are externally-facing and located along the autonomous vehicle with respect to a horizontal plane. For example, FIG. 2 provides a planar top-down view of the autonomous vehicle that is approximately parallel with a horizontal plane of the autonomous vehicle, and each of the plurality of cameras are located at different angular locations in the planar top-down view (camera location indicated by the vertex of a shown field-of-view).

The cameras may be located on an exterior surface of the autonomous vehicle or may be integrated into an exterior-facing portion of the autonomous vehicle such that the cameras are not significantly obstructed from collected image data of the exterior environment. In some embodiments, the cameras may be located on or within one or more racks, structures, scaffolds, apparatuses, or the like located on the autonomous vehicle, and the racks, structures, scaffolds, apparatuses, or the like may be removably attached to the autonomous vehicle. For example, cameras may be removed from the autonomous vehicle to enable easier adjustment, configuration, and maintenance of the cameras while the autonomous vehicle is not operating (e.g., to restore a desired FOV overlap amount).

While the cameras indicated in FIG. 2 are located in different locations along the horizontal plane of the autonomous vehicle, the cameras may also be located at different heights of the autonomous vehicle, or different locations along the vertical plane of the autonomous vehicle (not shown in FIG. 2). Additionally, while reference may be made to cameras in this patent document, it will be understood that various configurations and features thereof described herein may apply to configuration of externally-facing LiDAR units as well.

As shown in FIG. 2, cameras are located and oriented along the horizontal plane of the autonomous vehicle to provide 360-degree coverage of the external environment surrounding the autonomous vehicle. For example, the fields-of-view of the cameras span 360 degrees of orientations about the autonomous vehicle, or about anterior portion of the autonomous vehicle (e.g., the cab of a semi-trailer truck). Further, the cameras are located and oriented at different locations along the horizontal plane of the autonomous vehicle such that an amount of blind spots, or areas that are not captured by any one of the cameras, is minimized. In some embodiments, an area spanned by blind spots past a minimum distance from the autonomous vehicle is approximately zero.

To provide a minimization or lack of blind spots, the FOVs of the cameras are overlapped at least with respect to their horizontal aspects. For example, during operation of the autonomous vehicle, various vibrations experienced by the autonomous vehicle may result in slight orientation or position changes in the cameras, and to prevent the generation of a blind spot due to such slight changes, the FOVs of the cameras may overlap.

Furthermore, overlapped FOVs of the camera may enable improved object tracking at various orientations about the autonomous vehicle. For example, due to the horizontal overlap in camera FOVs, objects in motion (e.g., relative to the autonomous vehicle) can be detected by more than one camera at various points and can therefore be tracked in their motion with improved accuracy. In some embodiments, an expected relative speed of objects to be detected by the cameras may be used to determine an amount of horizontal overlap for the camera FOVs. For example, to detect objects moving at high relative speeds, the cameras may be configured with a larger horizontal overlap.

In some embodiments, the amount of horizontal overlap for camera FOVs is based on the speed of objects to be detected by the cameras and/or a frame rate of the cameras, or a frequency at which the cameras or sensors collect data. Thus, for example, given a slow frame rate, the amount of horizontal overlap for camera FOVs may be configured to be larger, as compared to an amount of horizontal overlap that may be implemented for cameras operated at higher frame rates. In some embodiments, the cameras may be operated at a frame rate that is synchronized with an overall system frequency, or a frequency at which multiple devices and sensors on the autonomous vehicle operate. For example, the cameras may be operated at a frame rate of 10 Hz to synchronize with LiDAR units on the autonomous vehicle that collect LiDAR data at 10 Hz. As such, the in-vehicle control computer 150 may receive data from multiple cameras, other sensors, and devices at a synchronized frequency and may process the data accordingly.

The overlapping of the camera FOVs as shown in FIG. 2 further provides redundancy to various cameras. With the redundancy of at least one redundant camera whose FOV horizontally overlaps that of a given camera, the at least one redundant camera can be relied upon in the event of failure or deficiency of the given camera. For example, the given camera may be physically impacted by debris while the autonomous vehicle travels on a roadway, may be rendered unusable due to hardware and/or software related issues, may be obstructed by dirt or mud on its lens, and/or the like. Thus, even if a given camera is unable to obtain reliable or useful image data, other redundant cameras whose FOVs horizontally overlap that of the given camera and that may also capture objects located within the FOV of the given camera can be used to maintain continued operation of object detection and tracking, and ultimately continued operation of the autonomous vehicle.

In some embodiments, while at least one camera may provide redundancy with a given camera, the at least one redundant camera may be located at a different location than the given camera. With there being an extent of separation between a given camera and its redundant cameras, a likelihood of localized physical damage that would render the given camera and its redundant cameras each inoperable or unreliable is lowered. Otherwise, given an example in which a given camera and its redundant backups are co-located, located on or within the same structure (e.g., a roof rack, a protruding member), physically connected, or the like, debris impacts could result in a significantly loss in camera FOV coverage.

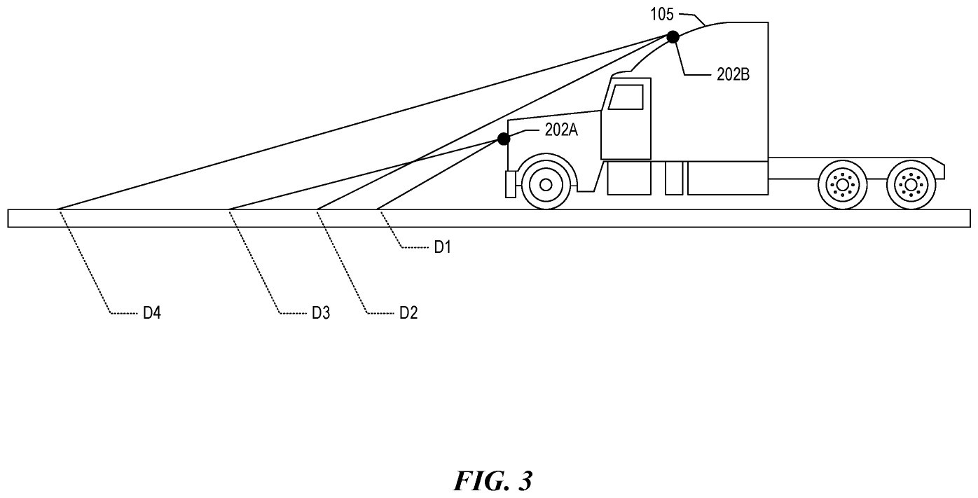

While example embodiments are described herein with respect to horizontal overlap of camera FOVs, the autonomous vehicle may include cameras whose FOVs vertically overlap, in some embodiments. In some embodiments, while a horizontal aspect of the fields-of-view of the cameras can be understood as defined as an angular width (e.g., in degrees), a vertical aspect of a camera field-of-view may be defined with respect to a range of distances that are captured within the camera field-of-view. FIG. 3 shows a diagram that illustrates definition of vertical aspects of camera FOVs as well as their overlaps. In particular, FIG. 3 illustrates two cameras 202A and 202B that are pointed approximately below the horizon, such that a field-of-view of each camera can be defined as an area on the ground and/or roadway. The vertical aspect of the field-of-view of each camera is then defined as a range of locations or distances, as shown in FIG. 3. For example, the vertical aspect of the field-of-view of the first camera 202A spans between points D1 and D3. Meanwhile, the vertical aspect of the field-of-view of the second camera 202B spans between points D2 and D4.

Thus, to configure vertical overlap of two camera FOVs, a predetermined amount of distance, or an overlap range of locations, may be used. As shown in the illustrated example, an overlap range may be determined as a distance (D3-D2), and the first camera 202A and the second camera 202B may be configured to vertically overlap accordingly. As a result, for example, objects located between points D2 and D3 (and aligned within a horizontal aspect or angular/beam width of the first and second cameras) may be captured by both the first camera 202A and the second camera 202B, while objects located between point D1 and D2 may only be captured by the first camera 202A and objects located between D3 and D4 may only be captured by the second camera 202B.

In some embodiments, overlap of camera FOVs (e.g., with respect to a horizontal aspect, with respect to a vertical aspect) may be achieved based on obtaining calibration data from the cameras. During a calibration operation of the autonomous vehicle, for example, the in-vehicle control computer 150 may obtain image data from the plurality of cameras and perform operations associated with image processing and image stitching techniques to determine a first degree of overlap for each pair of cameras. For example, the in-vehicle control computer 150 may be configured to identify reference objects in image data collected by a pair of cameras and determine the first degree of overlap of the pair of cameras based on the reference objects. Then, the in-vehicle control computer 150 may indicate the first degree of overlap for each pair of cameras, for example, to a human operator who may modify the orientation of the pair of cameras to reach the desired degree of overlap (e.g., 10 degrees horizontally, 12 degrees horizontally, 15 degrees horizontally, 17 degrees horizontally, 20 degrees horizontally, 30 degrees horizontally).

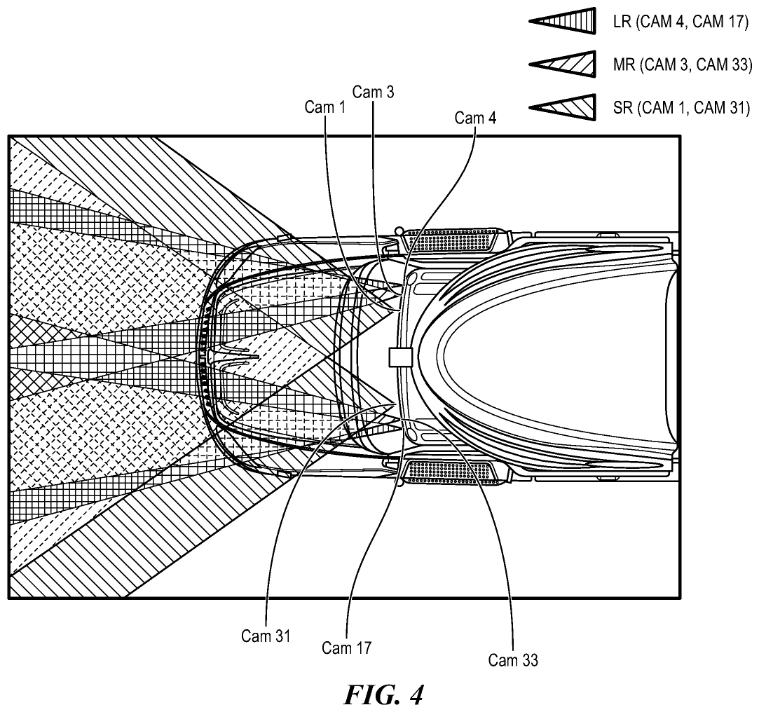

As shown in FIG. 4, different camera types may be included in a camera configuration for the autonomous vehicle. In some embodiments, the different camera types may be associated with different fields-of-view, and cameras of the different camera types may be configured to have overlapped fields-of-view as discussed above. In the illustrated example embodiment, the autonomous vehicle includes long-range (LR) cameras, medium-range (MR) cameras, and short-range (SR) cameras, although it will be understood that, in other embodiments, the autonomous vehicle may include cameras of other types including ultra-long-range or telescopic cameras, wide-angle lens/fisheye cameras, long wave infra-red cameras, and/or the like. In some embodiments, the range of a camera may correlate with its field-of-view, or aspects thereof. A long-range camera may be associated with an FOV of a small angular width or horizontal aspect (e.g., 15 degrees, 18 degrees, 20 degrees, 22 degrees), a medium-range camera may be associated with an FOV of a medium angular width or horizontal aspect (e.g., 25 degrees, 30 degrees, 35 degrees, 40 degrees), and a short-range camera may be associated with an FOV of a large angular width or horizontal aspect (e.g., 60 degrees, 63 degrees, 67 degrees, 70 degrees, 75 degrees, 80 degrees).

As illustrated in FIG. 4, consecutive or adjacent cameras, despite any different in camera type, may be configured with overlapping fields-of-view. For example, the FOV of Cam 1, which is a SR camera, overlaps with the adjacent or consecutive Cam 3, which is a MR camera. Due to the wider FOV of SR cameras, the FOV of Cam 1 further overlaps with Cam 4, which is a LR camera. In any regard, the fields-of-view of different cameras, which may be of different camera types, overlap by at least a predetermined amount (e.g., 10 degrees, 12 degrees, 15 degrees, 17 degrees, 20 degrees, 30 degrees).

Further, as illustrated in FIG. 4, the autonomous vehicle may include a pair of cameras for each camera type, or camera range. In some embodiments, the pair of cameras for each camera type (e.g., LR, MR, SR) may be located at symmetrical locations with respect to a central axis of the autonomous vehicle, or an axis spanning a length of the autonomous vehicle. The pair of cameras may be used for stereovision or binocular-based distance estimation of detected objects. For example, given information that indicates optical properties and data for each camera of a pair of cameras and given information that indicates a distance that separates the pair of cameras, a distance from the autonomous vehicle to an object detected by both cameras can be estimated. In some embodiments, the autonomous vehicle includes a pair of LR cameras that are used for stereovision or binocular-based distance estimation. In some embodiments, pairs of MR cameras and/or pairs of SR cameras may additionally be used for stereovision or binocular-based distance estimation. In some embodiments, the distance by which a pair of cameras is separated may be configured based on a desired accuracy of the distance estimations. Generally, if a pair of cameras are separated by a larger distance, distance estimation accuracy may be higher at farther ranges. Accordingly, in some embodiments including the illustrated embodiment of FIG. 4, a pair of LR cameras may be at wider locations of the autonomous vehicle, while a pair of MR cameras and a pair of SR cameras may be nested between the pair of LR cameras, as shown.

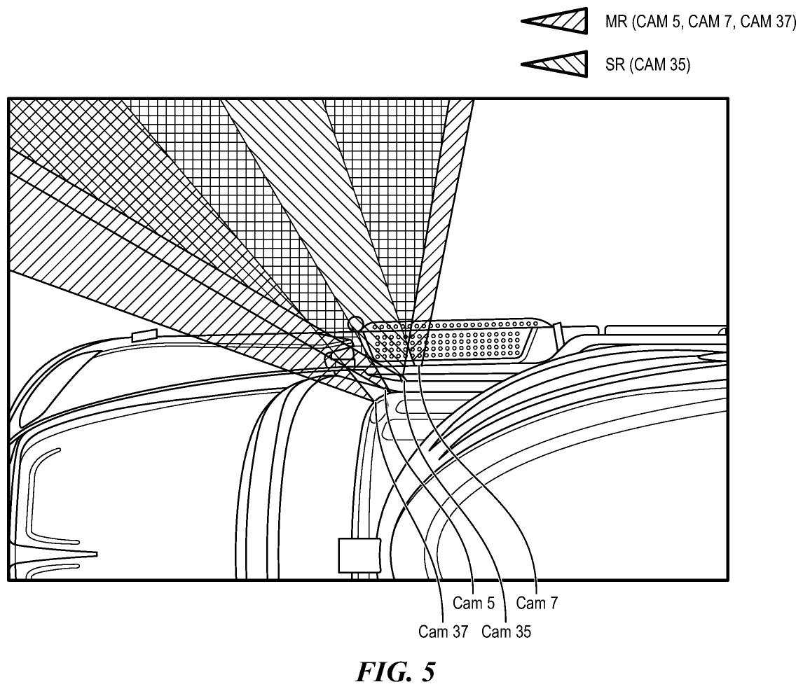

Turning to FIG. 5, another diagram is shown to demonstrate overlapped fields-of-view for cameras of different types, thereby providing redundancy for individual cameras while also spanning a wide range of orientations. In particular, FIG. 5 illustrates cameras oriented to capture a side of the autonomous vehicle. In some embodiments, the autonomous vehicle may include short range and medium range cameras for capturing the environment to the sides of the autonomous vehicle, as shown, due to an expectation that objects may be located at close distances to the sides of the autonomous vehicle (e.g., other vehicles traveling on a lane adjacent to a lane in which the autonomous vehicle is traveling).

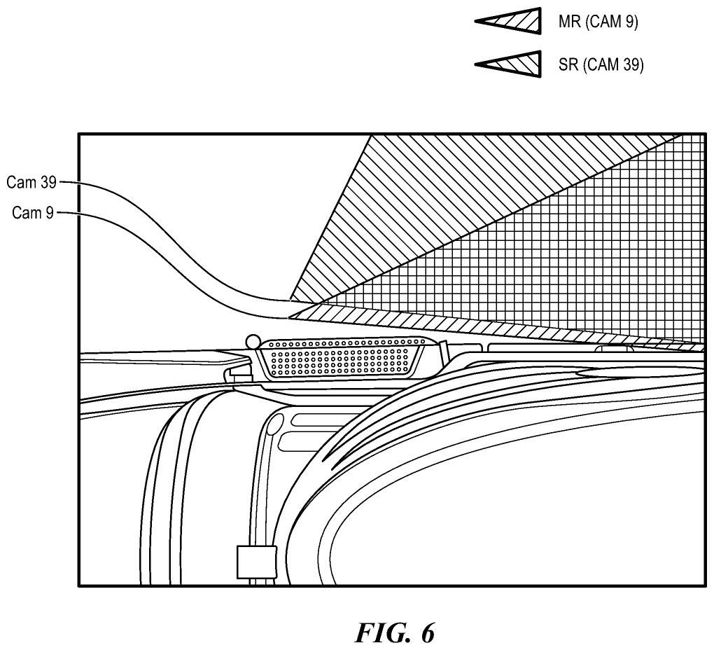

FIG. 6 provides yet another example configuration of cameras of different types whose fields-of-view horizontally overlap. The illustrated cameras are oriented to capture a side and rear portion of the environment surrounding the autonomous vehicle with redundancy. Redundancy may be further provided via coupling of the cameras with devices of the vehicle sensor subsystem 144 and/or with the in-vehicle control computer 150. In some embodiments, multiple cameras may be connected in a daisy-chain sequence to the in-vehicle control computer 150 or a computer of the vehicle sensor subsystem 144. In some embodiments, the vehicle sensor subsystem 144 may include multiple computers (e.g., microcontrollers, control modules, etc.), and redundant cameras (e.g., cameras whose FOVs overlap, such as Cam 9 and Cam 39 shown in FIG. 6) may be coupled with different computers. As such, failure of one computer to which a given camera (e.g., Cam 9) is coupled, or failure of the coupling itself, may not propagate to the redundant camera (e.g., Cam 39), and environmental awareness can be maintained (e.g., via Cam 39). In some embodiments, the redundant cameras are connected to the in-vehicle control computer 150 via separate ports or interfaces in a parallel manner, in contrast to a daisy-chain sequence.

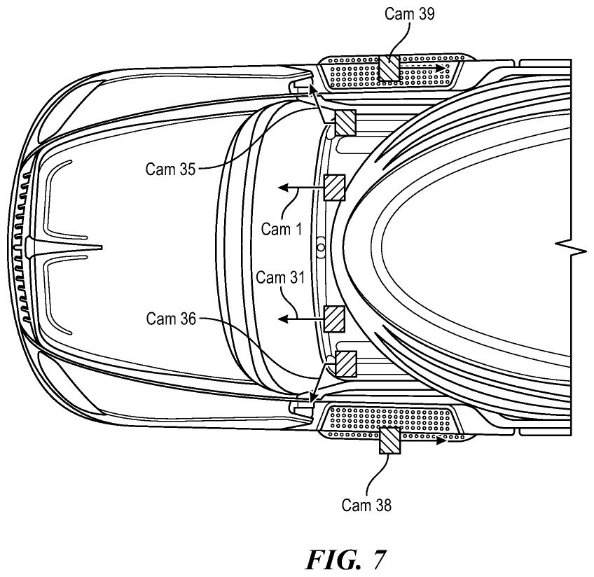

FIGS. 7, 8, 9, and 10 each provide diagrams illustrating different locations along the horizontal plane of the autonomous vehicle at which cameras of different types may be located. FIG. 7 illustrates locations and orientations of SR cameras on the autonomous vehicle, according to one example embodiment. As discussed, SR cameras may be associated with relatively wider FOVs and can efficiently span a wide range of orientations. As shown in FIG. 7, in one embodiment, six SR cameras may be used to span approximately 360 degrees of coverage. In some embodiments, the horizontal aspect of the SR camera FOV may be approximately 70 degrees (e.g., 60 degrees, 63 degrees, 67 degrees, 70 degrees, 75 degrees, 80 degrees). In some embodiments, the horizontal FOVs of the SR cameras overlap with at least each other by a predetermined amount. In some embodiments, the horizontal FOVs of the SR cameras overlap with each other and with other cameras (e.g., MR cameras, LR cameras) by a predetermined amount.

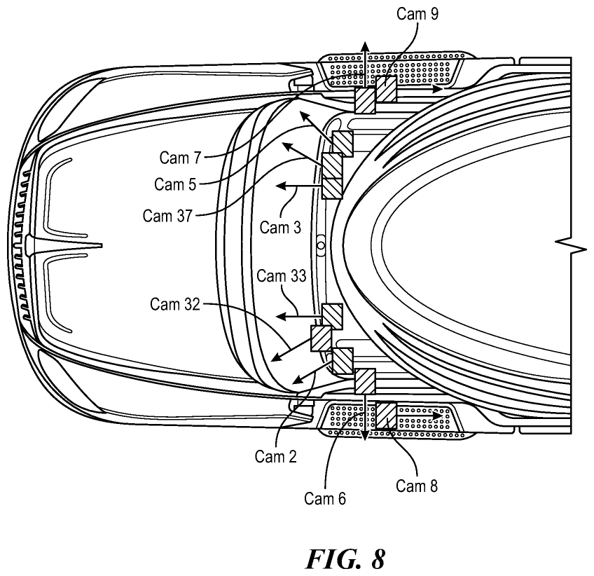

While SR cameras can span a wide range of orientations, the autonomous vehicle may further include MR cameras and LR cameras for longer-range detection of objects. In particular, with high-speed operation of the autonomous vehicle, detection and tracking of objects at farther distances via MR cameras and LR cameras enables safe and compliant operation of the autonomous vehicle. FIG. 8 illustrates locations and orientations of MR cameras on the autonomous vehicle, according to one example embodiment. In the illustrated embodiment, the autonomous vehicle may include ten MR cameras that span approximately 360 degrees of coverage and that overlap with each other. The MR cameras may also overlap with other cameras. In some embodiments, the horizontal aspect of the MR camera FOV may be approximately 30 degrees (e.g., 25 degrees, 30 degrees, 35 degrees, 40 degrees).

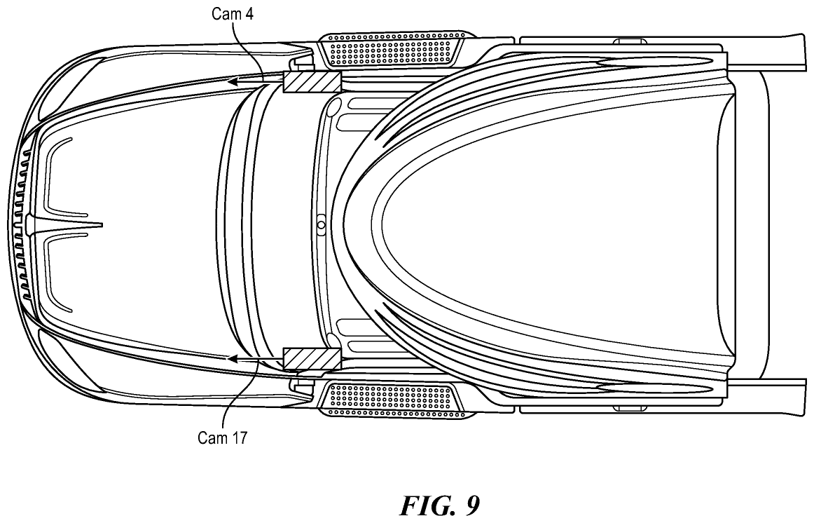

FIG. 9 illustrates locations and orientations of LR cameras on the autonomous vehicle, according to one example embodiment. As shown, the autonomous vehicle may include two long range cameras oriented towards the front of the autonomous vehicle. In some embodiments, the LR cameras may be used for stereovision or binocular-based distance estimations. In some embodiments, the horizontal aspect of the LR camera FOV may be approximately 18 degrees (e.g., 15 degrees, 18 degrees, 20 degrees, 22 degrees).

In some embodiments, each of the LR cameras, MR cameras, and the SR cameras may be associated with a corresponding overlap amount. For instance, the SR cameras may overlap with each other by a first overlap amount, the MR cameras may overlap with each other by a second overlap amount, and the LR cameras may overlap with each other by a third overlap amount. Further, in some embodiments, there may be an overlap amount configured for overlaps of different camera types. For example, SR cameras and MR cameras may overlap with each other by a fourth overlap amount, MR cameras and LR cameras may overlap with each other by a fifth overlap amount, and SR and LR cameras may overlap with each other by a sixth overlap amount, in some embodiments.

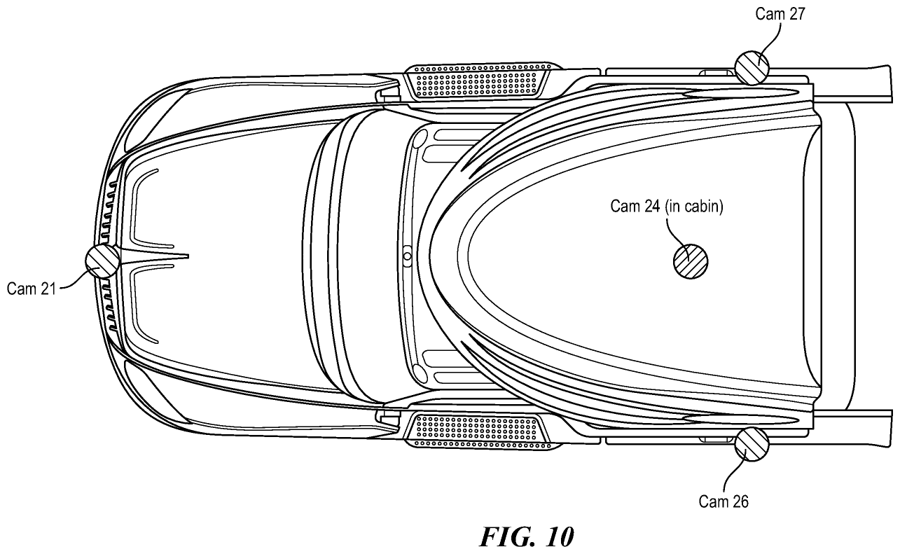

FIG. 10 illustrates locations and orientations of wide-angle lens cameras on the autonomous vehicle, according to one example embodiment. In some embodiments, wide-angle lens cameras may be used at least at the sides of the autonomous vehicle for detection and tracking of proximate objects, or objects located close to the autonomous vehicle. In some embodiments, the horizontal aspect of the wide-angle lens camera FOV may be approximately 200 degrees (e.g., 150 degrees, 170 degrees, 200 degrees, 225 degrees, 250 degrees).

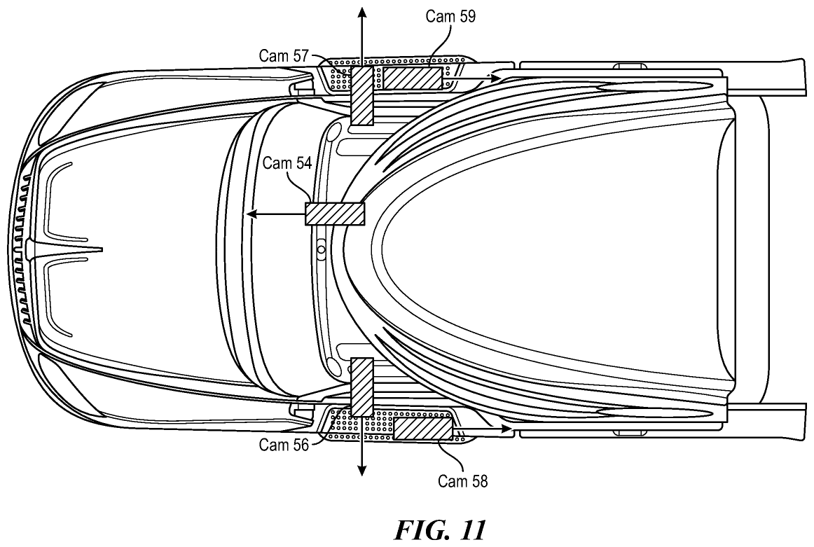

FIG. 11 illustrates an example sensor configuration that includes a plurality of infra-red cameras. In some embodiments, the plurality of infra-red cameras includes long wave infra-red cameras that are configured to capture image data that corresponds to a long way infra-red (LWIR) spectrum. Other variants of infra-red cameras can be included. The plurality of infra-red cameras are included in sensor configurations that include LR cameras, MR cameras, and SR cameras, and a field-of-view of the infra-red cameras overlap with those of the LR cameras, the MR cameras, and the SR cameras by a predetermined amount, in accordance with embodiments described herein.

Accordingly, in some embodiments, the autonomous vehicle includes cameras configured for different ranges and cameras configured to different spectrums. Cameras configured for infra-red spectrum can supplement occasional deficiencies of cameras configured for visible light, such as in environments with heavy rain, fog, or other conditions. Thus, with heterogenous camera ranges and heterogenous camera spectrums, an autonomous vehicle is equipped with awareness for multiple different scenarios.

As illustrated in FIG. 11, an autonomous vehicle includes five infra-red cameras that are oriented to cover a range of orientations, in some embodiments. For example, two cameras (e.g., Cam 59, Cam 58) are oriented towards a rear of the vehicle, two cameras (e.g., Cam 57, Cam 56) are oriented in lateral directions of the vehicle, and one camera (Cam 54) is oriented towards the front direction of the vehicle.

Camera configurations described herein in accordance with some example embodiments may be based on optimizations of different priorities and objectives. While one objective is to minimize the number of cameras necessary for full 360 degree coverage surrounding the autonomous vehicle, other objectives that relate to range, redundancy, FOV overlap, and stereovision and be considered as well. With example embodiments described herein, cameras may be configured to provide full environmental awareness for an autonomous vehicle, while also providing redundancy and enabling continued operation in the event of individual camera failure or deficiency, and also providing capabilities for object tracking and ranging at high speeds.

In an embodiment, an autonomous vehicle comprises a plurality of first cameras associated with a first FOV having a first horizontal aspect and a plurality of second cameras associated with a second FOV having a second horizontal aspect. The first cameras and the second cameras are located at different angular locations on the autonomous vehicle along a horizontal plane. Horizontal aspects of two fields-of-view of any two consecutive cameras located along the horizontal plane overlap in the horizontal plane by at least a predetermined number of degrees.

In an embodiment, the first cameras and the second cameras are operated at a corresponding frame rate, and wherein the predetermined number of degrees is based on (i) the any two consecutive cameras being two first cameras, two second cameras, or a first camera and a second camera, and (ii) the corresponding frame rate for the any two consecutive cameras.

In an embodiment, the corresponding frame rate for the first cameras and the second cameras is a universal frequency that is synchronized with a sensor frequency of at least one light detection and ranging sensor located on the autonomous vehicle.

In an embodiment, the predetermined number of degrees is further based on an expected speed at which objects located outside of the autonomous vehicle are in motion relative to the autonomous vehicle.

In an embodiment, respective fields-of-view of the plurality of first cameras and the plurality of second cameras together continuously span 360 degrees about the autonomous vehicle.

In an embodiment, the first cameras are associated with a first camera range. The second cameras are associated with a second camera range that is different from the first camera range. The angular locations on the autonomous vehicle at which the first cameras and the second cameras are located are based on the first camera range of the first cameras and the second camera range of the second cameras.

In an embodiment, the plurality of first cameras includes a pair of first cameras that are separated by a distance that is configured for stereovision-based detection of objects located within the first FOV of each of the pair of first cameras.

In an embodiment, the pair of first cameras are located at a front of the autonomous vehicle and oriented in a forward orientation, and wherein the distance by which the pair of first cameras is separated is perpendicular to a central axis along a length of the autonomous vehicle.

In an embodiment, the any two consecutive cameras are electronically coupled in parallel via separate interfaces to a computer located on the autonomous vehicle that is configured to operate the autonomous vehicle.

In an embodiment, the different angular locations on the autonomous vehicle at which the first cameras and the second cameras are located are symmetrical with respect to a central axis along a length of the autonomous vehicle.

In an embodiment, the first FOV has a first vertical aspect being defined by a range of distances from the autonomous vehicle. The autonomous vehicle further comprises a plurality of third cameras that are located on the autonomous vehicle and having a third FOV having a third vertical aspect. At least one third camera and at least one first camera are oriented such that respective vertical aspects of the respective FOVs of the at least one third camera and the at least one first camera overlap by a predetermined amount.

In an embodiment, the autonomous vehicle further comprises at least one wide-angle camera located at each lateral side of the autonomous vehicle.

In an embodiment, a sensor network for an autonomous vehicle comprises: a plurality of first cameras associated with a first FOV having a first horizontal aspect; and a plurality of second cameras associated with a second FOV having a second horizontal aspect. The first cameras and the second cameras are located at different angular locations on the autonomous vehicle along a horizontal plane. Horizontal aspects of two fields-of-view of any two consecutive cameras located along the horizontal plane of the autonomous vehicle overlap in the horizontal plane by at least a predetermined number of degrees.

In an embodiment, the first cameras and the second cameras are operated at a corresponding frame rate, and wherein the predetermined number of degrees is based on (i) the any two consecutive cameras being two first cameras, two second cameras, or a first camera and a second camera, and (ii) the corresponding frame rate for the any two consecutive cameras.

In an embodiment, the corresponding frame rate for the first cameras and the second cameras is a universal frequency that is synchronized with a sensor frequency of at least one light detection and ranging sensor located on the autonomous vehicle.

In an embodiment, the predetermined number of degrees is further based on an expected speed at which objects located outside of the autonomous vehicle are in motion relative to the autonomous vehicle.

In an embodiment, respective fields-of-view of the plurality of first cameras and the plurality of second cameras together continuously span 360 degrees about the autonomous vehicle.

In an embodiment, the first cameras are associated with a first camera range. The second cameras are associated with a second camera range that is different from the first camera range. The different angular locations on the autonomous vehicle at which the first cameras and the second cameras are located are based on the first camera range of the first cameras and the second camera range of the second cameras.

In an embodiment, the plurality of first cameras includes a pair of first cameras that are separated by a distance that is configured for stereovision-based detection of objects located within the first FOV of each of the pair of first cameras.

In an embodiment, the pair of first cameras are located at a front of the autonomous vehicle and oriented in a forward orientation, and wherein the distance by which the pair of first cameras is separated is perpendicular to a central axis along a length of the autonomous vehicle.

In an embodiment, the sensor network further comprises a computer configured to operate the autonomous vehicle, wherein the any two consecutive cameras are electronically coupled in parallel via separate interfaces to the computer.

In an embodiment, the different angular locations on the autonomous vehicle at which the first cameras and the second cameras are located are symmetrical with respect to a central axis along a length of the autonomous vehicle.

In an embodiment, the first FOV has a first vertical aspect being defined by a range of distances from the autonomous vehicle. The sensor network further comprises a plurality of third cameras that are located on the autonomous vehicle and having a third FOV having a third vertical aspect. At least one third camera and at least one first camera are oriented such that respective vertical aspects of the respective FOVs of the at least one third camera and the at least one first camera overlap by a predetermined amount.

In an embodiment, the sensor network further comprises at least one wide-angle camera located at each lateral side of the autonomous vehicle.

In an embodiment, a system for operating an autonomous vehicle comprises: a processor communicatively coupled with and configured to receive image data from a plurality of first cameras that are associated with a first FOV having a first horizontal aspect and a plurality of second cameras that are associated with a second FOV having a second horizontal aspect. The first cameras and the second cameras are located at different angular locations on the autonomous vehicle along a horizontal plane. Horizontal aspects of two fields-of-view of any two consecutive cameras located along the horizontal plane of the autonomous vehicle overlap in the horizontal plane by at least a predetermined number of degrees.

In an embodiment, the image data is received from the first cameras and the second cameras at a corresponding frame rate for the first cameras and the second cameras, and wherein the predetermined number of degrees is based on (i) the any two consecutive cameras being two first cameras, two second cameras, or a first camera and a second camera, and (ii) the corresponding frame rate for the any two consecutive cameras.

In an embodiment, the corresponding frame rate for the first cameras and the second cameras is a universal frequency that is synchronized with a sensor frequency of at least one light detection and ranging sensor located on the autonomous vehicle.

In an embodiment, the predetermined number of degrees is further based on an expected speed at which objects located outside of the autonomous vehicle are in motion relative to the autonomous vehicle.

In an embodiment, respective fields-of-view of the plurality of first cameras and the plurality of second cameras together continuously span 360 degrees about the autonomous vehicle.

In an embodiment, the first cameras are associated with a first camera range. The second cameras are associated with a second camera range that is different from the first camera range, and the different angular locations on the autonomous vehicle at which the first cameras and the second cameras are located are based on the first camera range of the first cameras and the second camera range of the second cameras.

In an embodiment, the processor is configured to execute operations for stereovision-based detection of objects from a pair of first cameras of the plurality of first cameras that are separated by a predetermine distance.

In an embodiment, the pair of first cameras are located at a front of the autonomous vehicle and oriented in a forward orientation, and wherein the distance by which the pair of first cameras is separated is perpendicular to a central axis along a length of the autonomous vehicle.

In an embodiment, the any two consecutive cameras are communicatively coupled in parallel via separate interfaces to the processor.

In an embodiment, the different angular locations on the autonomous vehicle at which the first cameras and the second cameras are located are symmetrical with respect to a central axis along a length of the autonomous vehicle.

In an embodiment, the first FOV has a first vertical aspect being defined by a range of distances from the autonomous vehicle. The processor is further communicatively coupled with a plurality of third cameras that are located on the autonomous vehicle and having a third FOV having a third vertical aspect. At least one third camera and at least one first camera are oriented such that respective vertical aspects of the respective FOVs of the at least one third camera and the at least one first camera overlap by a predetermined amount.

In an embodiment, the processor is further communicatively coupled with at least one wide-angle camera located at each lateral side of the autonomous vehicle.

In an embodiment, a method for operating an autonomous vehicle comprises receiving image data from a sensor network, the sensor network comprising: a plurality of first cameras associated with a first FOV having a first horizontal aspect and a plurality of second cameras associated with a second FOV having a second horizontal aspect. The first cameras and the second cameras are located at different angular locations on the autonomous vehicle along a horizontal plane, and horizontal aspects of two fields-of-view of any two consecutive cameras located along the horizontal plane overlap in the horizontal plane by at least a predetermined number of degrees. The method further comprises detecting one or more objects located outside of the autonomous vehicle based on the image data; determining a trajectory for the autonomous vehicle based on the detection of the one or more objects; and causing the autonomous vehicle to travel in accordance with the trajectory.

In an embodiment, detecting the one or more objects comprises estimating a distance between the autonomous vehicle and each of the one or more objects based on (i) each object being captured by each of a pair of first cameras of the plurality of first cameras, and (ii) a stereovision separation distance between the pair of first cameras.

In an embodiment, the one or more objects are in motion relative to the autonomous vehicle, and wherein detecting the one or more objects comprises tracking each object as the objects moves from an FOV of a given camera of the plurality of first cameras or the plurality of second cameras to an FOV of another camera of the plurality of first cameras or the plurality of second cameras.

In an embodiment, an autonomous truck comprises a controller configured to control autonomous driving operation of the truck and a sensor network comprising at least six sensors disposed on an exterior of the truck, each sensor oriented to capture sensor data from a corresponding directional beam having a corresponding beam width and a corresponding beam depth such that beam widths of the at least six sensors cover a surrounding region of the truck that is relevant to safe autonomous driving of the truck.

In an embodiment, the corresponding directional beam of the at least six sensors overlap by at least a predetermined amount with respect to the corresponding beam width.

In an embodiment, a first subset of the at least six sensors are configured to capture image data corresponding to a visible spectrum, and wherein a second subset of the at least six sensors are configured to capture image data corresponding to a LWIR spectrum.

In an embodiment, the second subset of the at least six sensors is five LWIR cameras.

In this document the term “exemplary” is used to mean “an example of” and, unless otherwise stated, does not imply an ideal or a preferred embodiment. In this document, the term “microcontroller” can include a processor and its associated memory.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A sensor network for an autonomous vehicle, the sensor network comprising:
a plurality of first cameras associated with a first field-of-view (FOV) having a first horizontal aspect; and
a plurality of second cameras associated with a second FOV having a second horizontal aspect,
wherein the first cameras and the second cameras are located at different angular locations on the autonomous vehicle along a horizontal plane, and
wherein horizontal aspects of two fields-of-view of any two consecutive cameras located along the horizontal plane of the autonomous vehicle overlap in the horizontal plane by at least a predetermined number of degrees.

2. The sensor network of claim 1, wherein the first cameras and the second cameras are operated at a corresponding frame rate, and wherein the predetermined number of degrees is based on (i) the any two consecutive cameras being two first cameras, two second cameras, or a first camera and a second camera, and (ii) the corresponding frame rate for the any two consecutive cameras.

3. The sensor network of claim 2, wherein the corresponding frame rate for the first cameras and the second cameras is a universal frequency that is synchronized with a sensor frequency of at least one light detection and ranging sensor located on the autonomous vehicle.

4. The sensor network of claim 2, wherein the predetermined number of degrees is further based on an expected speed at which objects located outside of the autonomous vehicle are in motion relative to the autonomous vehicle.

5. The sensor network of claim 1, wherein respective fields-of-view of the plurality of first cameras and the plurality of second cameras together continuously span 360 degrees about the autonomous vehicle.

6. The sensor network of claim 1,
wherein the first cameras are associated with a first camera range,
wherein the second cameras are associated with a second camera range that is different from the first camera range, and
wherein the different angular locations on the autonomous vehicle at which the first cameras and the second cameras are located are based on the first camera range of the first cameras and the second camera range of the second cameras.

7. The sensor network of claim 1, wherein the plurality of first cameras includes a pair of first cameras that are separated by a distance that is configured for stereovision-based detection of objects located within the first FOV of each of the pair of first cameras.

8. The sensor network of claim 7, wherein the pair of first cameras are located at a front of the autonomous vehicle and oriented in a forward orientation, and wherein the distance by which the pair of first cameras is separated is perpendicular to a central axis along a length of the autonomous vehicle.

9. The sensor network of claim 1, further comprising a computer configured to operate the autonomous vehicle, wherein the any two consecutive cameras are electronically coupled in parallel via separate interfaces to the computer.

10. The sensor network of claim 1, wherein the different angular locations on the autonomous vehicle at which the first cameras and the second cameras are located are symmetrical with respect to a central axis along a length of the autonomous vehicle.

11. The sensor network of claim 1,
wherein the first FOV has a first vertical aspect being defined by a range of distances from the autonomous vehicle,
wherein the sensor network further comprises a plurality of third cameras that are located on the autonomous vehicle and having a third FOV having a third vertical aspect, and
wherein at least one third camera and at least one first camera are oriented such that respective vertical aspects of the respective FOVs of the at least one third camera and the at least one first camera overlap by a predetermined amount.

12. The sensor network of claim 1, further comprising at least one wide-angle camera located at each lateral side of the autonomous vehicle.

13. A system for operating an autonomous vehicle, the system comprising:
a processor communicatively coupled with and configured to receive image data from:
a plurality of first cameras that are associated with a first field-of-view (FOV) having a first horizontal aspect; and
a plurality of second cameras that are associated with a second FOV having a second horizontal aspect,
wherein the first cameras and the second cameras are located at different angular locations on the autonomous vehicle along a horizontal plane, and
wherein horizontal aspects of two fields-of-view of any two consecutive cameras located along the horizontal plane of the autonomous vehicle overlap in the horizontal plane by at least a predetermined number of degrees.

14. The system of claim 13, wherein respective fields-of-view of the plurality of first cameras and the plurality of second cameras together continuously span 360 degrees about the autonomous vehicle.

15. The system of claim 13,
wherein the first cameras are associated with a first camera range,
wherein the second cameras are associated with a second camera range that is different from the first camera range, and
wherein the different angular locations on the autonomous vehicle at which the first cameras and the second cameras are located are based on the first camera range of the first cameras and the second camera range of the second cameras.

16. The system of claim 13, wherein the different angular locations on the autonomous vehicle at which the first cameras and the second cameras are located are symmetrical with respect to a central axis along a length of the autonomous vehicle.

17. The system of claim 13,
wherein the first FOV has a first vertical aspect being defined by a range of distances from the autonomous vehicle,
wherein the processor is further communicatively coupled with a plurality of third cameras that are located on the autonomous vehicle and having a third FOV having a third vertical aspect, and
wherein at least one third camera and at least one first camera are oriented such that respective vertical aspects of the respective FOVs of the at least one third camera and the at least one first camera overlap by a predetermined amount.

18. A method for operating an autonomous vehicle, comprising:
receiving image data from a sensor network, the sensor network comprising:
a plurality of first cameras associated with a first field-of-view (FOV) having a first horizontal aspect and a plurality of second cameras associated with a second FOV having a second horizontal aspect,
wherein the first cameras and the second cameras are located at different angular locations on the autonomous vehicle along a horizontal plane, and
wherein horizontal aspects of two fields-of-view of any two consecutive cameras located along the horizontal plane overlap in the horizontal plane by at least a predetermined number of degrees;
detecting one or more objects located outside of the autonomous vehicle based on the image data;
determining a trajectory for the autonomous vehicle based on the detection of the one or more objects; and
causing the autonomous vehicle to travel in accordance with the trajectory.

19. The method of claim 18, wherein detecting the one or more objects comprises estimating a distance between the autonomous vehicle and each of the one or more objects based on (i) each object being captured by each of a pair of first cameras of the plurality of first cameras, and (ii) a stereovision separation distance between the pair of first cameras.

20. The method of claim 18, wherein the one or more objects are in motion relative to the autonomous vehicle, and wherein detecting the one or more objects comprises tracking each object as the objects moves from an FOV of a given camera of the plurality of first cameras or the plurality of second cameras to an FOV of another camera of the plurality of first cameras or the plurality of second cameras.
